(19) United States
(12) Patent Application Publication
(10) Pub. No.: US 2015/0348656 A1
(43) Pub. Date: Dec. 3, 2015

(54) NEUTRON FLUX LEVEL MEASUREMENT SYSTEM, NEUTRON FLUX LEVEL COMPUTING DEVICE AND NEUTRON FLUX LEVEL MEASUREMENT METHOD

(71) Applicant: Kabushiki Kaisha Toshiba, Minato-ku (JP)

(72) Inventors: Shigehiro KONO, Tama (JP); Daijiro ITO, Kodaira (JP); Hideyuki KITAZONO, Fuchu (JP)

(73) Assignee: Kabushiki Kaisha Toshiba, Minato-ku (JP)

(21) Appl. No.: 14/626,158

(22) Filed: Feb. 19, 2015

(30) Foreign Application Priority Data
May 28, 2014 (JP) 2014-110141

(51) Int. Cl. G21C 17/108

(52) U.S. Cl. CPC G21C 17/108; G21Y 2004/40

(57) ABSTRACT

According to one embodiment, a neutron flux level computing component has: an analog signal processing system that amplifies an AC component of a detector output signal from a neutron detector and performs filtering for removal of a high-frequency component; a digitization system that converts, at a certain sampling period, an output signal from the analog signal processing system into a digital time-series signal; a wavelet analysis system that performs discrete wavelet transformation using the digital time-series signal to compute a wavelet coefficient; and a digital signal processing system that computes a mean square value of the wavelet coefficients and converts the computed mean square value into a neutron flux level value.

### CROSS-REFERENCE TO RELATED APPLICATION

This application is based upon and claims the benefit of priority from Japanese Patent Application No. 2014-110141 filed on May 28, 2014, the entire content of which is incorporated herein by reference.

### FIELD

Embodiments of the present invention relate to a neutron flux level measurement system, a neutron flux level computing device and a neutron flux level measurement method.

### BACKGROUND

Neutrons generated in a fission reactor such as a light-water reactor of a commercial nuclear power plant are measured using a fission chamber because of its excellent discrimination performance from y-rays. In a state where reactor power level is low, an output signal of the fission chamber is counted as pulse signals. When the reactor power level becomes high to a certain degree, pulse signals overlap each other, making it impossible to individually count the output signals of the fission chamber. Thus, a Campbell method that uses statistical fluctuation of the detector output signal is used to measure the neutrons.

In a fusion reactor, duration time of nuclear fusion reaction (D-D reaction) of heavy hydrogen is increased by recent technical progress to increase the number of neutrons to be generated by the D-D reaction. Thus, it is necessary to use the fission chamber in a Campbell measurement region beyond a pulse measurement region when the neutrons generated from the fusion reactor are measured.

Accuracy of a result obtained from the measurement using the Campbell method depends upon a time constant of an averaging circuit at an output stage of a measuring device, and it is known that the larger the time constant, the higher the accuracy becomes.

In the neutron measurement using the Campbell method, an input signal is square-averaged for computation of the statistical fluctuation of the detector output signal, so that the measurement is subject to a noise signal when the noise signal is superimposed on the input signal.

In recent years, an inverter device that generates high-frequency noise of, for example, about 1 MHz is often used in a power supply device or an electric machine. In order to prevent the high-frequency noise from influencing the neutron measurement device, it is necessary to apply countermeasures, such as enhancement of shielding performance of a measurement system, and installation of a ferrite core in a noise propagation path, to the neutron measurement device.

As the countermeasures against the noise, a conventional neutron measurement device includes, in a signal processing circuit that processes the detector output signal (analog signal) from the neutron detector, a preamplifier, an AC amplifier, an analog filter, a square operation circuit, and a time constant circuit to apply filtering processing to an input or output signal. However, it is difficult for a conventional analog filter or a digital filter to realize perfect filtering characteristics and, thus, the influences of the noise cannot be removed completely. Such technologies are disclosed in Japanese Patent Application Laid-Open Publication No. 2007-240464, and Japanese Patent No. 5,159,645, the entire contents of which are incorporated herein by reference.

### BRIEF DESCRIPTION OF THE DRAWINGS

The features and advantages of the present invention will become apparent from the discussion hereinbelow of specific, illustrative embodiments thereof presented in conjunction with the accompanying drawings, wherein:

FIG. 1 is a block diagram illustrating a configuration of a neutron flux level measurement system according to a first embodiment;

FIG. 2 is a flowchart illustrating a procedure of the neutron flux level measurement method according to the first embodiment;

FIG. 3 is a graph illustrating an example of a temporal change of the output signal of the neutron detector;

FIG. 4 is a graph illustrating a result of the wavelet transformation;

FIG. 5 is a graph illustrating a result of the wavelet transformation in a case where a bandwidth is limited;

FIG. 6 is a graph illustrating a result of the wavelet transformation in a case where the bandwidth limitation and noise removal are performed;

FIG. 7 is a block diagram illustrating a configuration of the neutron flux level measurement system according to a second embodiment;

FIG. 8 is a block diagram illustrating a configuration of the neutron flux level measurement system according to a third embodiment;

FIG. 9 is a block diagram illustrating a configuration of the neutron flux level measurement system according to a fourth embodiment;

FIG. 10 is a block diagram illustrating a configuration of a modification of the neutron flux level measurement system according to the fourth embodiment;

FIG. 11 is a block diagram illustrating a configuration of the neutron flux level measurement system according to a fifth embodiment; and

FIG. 12 is a block diagram illustrating a configuration of the neutron flux level measurement system according to a sixth embodiment.

### DETAILED DESCRIPTION

Embodiments of the present invention have been made to solve the above problem, and an object thereof is to quickly perform measurement of a neutron flux level while removing influences of the noise.

According to an embodiment, there is provided a neutron flux level computing device comprising: an analog signal processing system that amplifies an AC component of a detector output signal from a neutron detector and performs filtering for removal of a high-frequency component; a digitization system that converts, at a certain sampling period, an output signal from the analog signal processing system into a digital time-series signal; a wavelet analysis system that performs discrete wavelet transformation using the digital time-series signal to compute a wavelet coefficient; and a digital signal processing system that computes a mean square value of the wavelet coefficients and converts the computed mean square value into a neutron flux level value.

According to an embodiment, there is provided a neutron flux level measurement system, comprising: a neutron detector that detects neutrons generated by nuclear reaction; and a neutron flux level computing device that computes a neutron flux level based on a signal from the neutron detector, the device including: an analog signal processing system that amplifies an AC component of a detector output signal from a neutron detector and performs filtering for removal of a high-frequency component; a digitization system that converts, at a certain sampling period, an output signal from the analog signal processing system into a digital time-series signal; a wavelet analysis system that performs discrete wavelet transformation using the digital time-series signal to compute a wavelet coefficient; and a digital signal processing system that computes a mean square value of the wavelet coefficients and converts the computed mean square value into a neutron flux level value.

According to an embodiment, there is provided a neutron flux level measurement method comprising: an analog signal processing step of amplifying an AC component of a detector output signal from a neutron detector and of performing low-pass filtering for removal of a high-frequency component; a digitization step of digitizing, at a certain sampling period and in a time-series manner, the detector output signal that has been subjected to the low-pass filtering; a wavelet transformation step of performing discrete wavelet transformation to the digitized detection output signal into wavelet coefficients; and a level value conversion step of computing a mean square value of some wavelet coefficients selected from the wavelet coefficients obtained through the discrete wavelet transformation and converting the computed mean square value into a neutron flux level value.

Now, embodiments of a neutron flux level measurement system, a neutron flux level computing device and a neutron flux level measurement method will be described by referring to the accompanying drawings. Throughout the drawings, the same or similar components are denoted by the same reference symbols and will not be described repeatedly.

### First Embodiment

The present embodiment relates to a neutron flux level measurement system 100, a neutron flux level computing device 90, and a neutron flux level measurement method that target neutrons generated by nuclear reaction, such as neutrons generated by nuclear fission in a reactor core or neutrons generated in a fusion reactor.

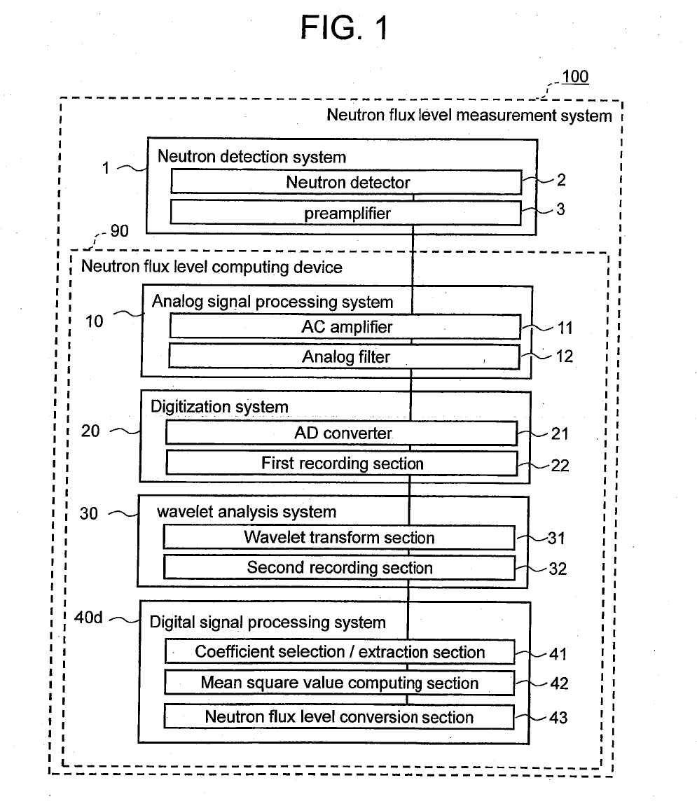

FIG. 1 is a block diagram illustrating a configuration of a neutron flux level measurement system according to a first embodiment. A neutron flux level measurement system 100 includes a neutron detection system 1 and a neutron flux level computing device 90.

The neutron detection system 1 is a part that detects neutrons and outputs a corresponding detection signal and includes a neutron detector 2 and a preamplifier 3. The neutron detector 2 is, for example, a fission chamber. A startup range monitor detector may be used in the case of a boiling water reactor. The preamplifier 3 amplifies a weak signal of the neutron detector 2.

The neutron flux level computing device 90 includes an analog signal processing system 10, a digitization system 20, a wavelet analysis system 30, and a digital signal processing system 40. The analog signal processing system 10 includes an AC amplifier 11 and an analog filter 12. The AC amplifier 11 extracts a statistical fluctuation component, i.e., an AC signal component from an output signal of the preamplifier 3 and amplifies it. Specifically, the AC amplifier 11 uses a capacitor coupling scheme to allow only the AC component to pass therethrough and then amplifies it.

The analog filter 12 removes a high-frequency component equal to or higher than a frequency (Nyquist frequency) a half of a sampling frequency of an AD converter 21 to be described later from an output signal corresponding to the AC signal component amplified by the AC amplifier 11. This prevents aliasing from being generated through sampling. The filtering may be performed by using a low-pass filter or the like.

The digitization system 20 includes an AD converter 21 and a first memory 22. The analog filter 12 filters and removes high-frequency component of its input. The AD converter 21 digitizes, at a predetermined sampling period, the output signal of the analog filter 12. Further, the first memory 22 memorizes a digital signal obtained as a result of the digitization. The sampling period is shorter than a period that can cover the statistical fluctuation component. However, the sampling period is not made excessively shorter in terms of a burden on computation processing to be described later.

The wavelet analysis system 30 includes a wavelet transformation section 31 and a second memory 32. The wavelet transformation section 31 applies wavelet transformation to a time domain signal that has been digitized by the digitization system 20 into a wavelet coefficient. The wavelet transformation is disclosed in as illustrated in “Ten Lectures on Wevlets” I. Daubechies, SIAM, Philadelphia, 1992. An orthonormal basis, i.e., a function that can reproduce an original time domain signal by inverse transformation, is used as a mother wavelet of each level in the wavelet transformation. The second memory 32 memorizes the wavelet coefficient computed by the wavelet transformation section 31.

The digital signal processing system 40 includes a coefficient selection/extraction section 41, a mean square value computing section 42, and a neutron flux level conversion section 43. The coefficient selection/extraction section 41 selects and extracts a necessary wavelet coefficient from a result of the computation performed by the wavelet transformation section 31. That is, the coefficient selection/extraction section 41 performs selection/extraction based on frequency information, selection/extraction based on time information and removal of a noise component. The mean square value computing section 42 computes a mean square value of the wavelet coefficients selected and extracted by the coefficient selection/extraction section 41. The mean square value corresponds to a neutron flux level, like a fluctuation component of the output of the neutron detector 2 in a time domain. The neutron flux level conversion section 43 converts the mean square value computed by the mean square value computing section 42 into the neutron flux level.

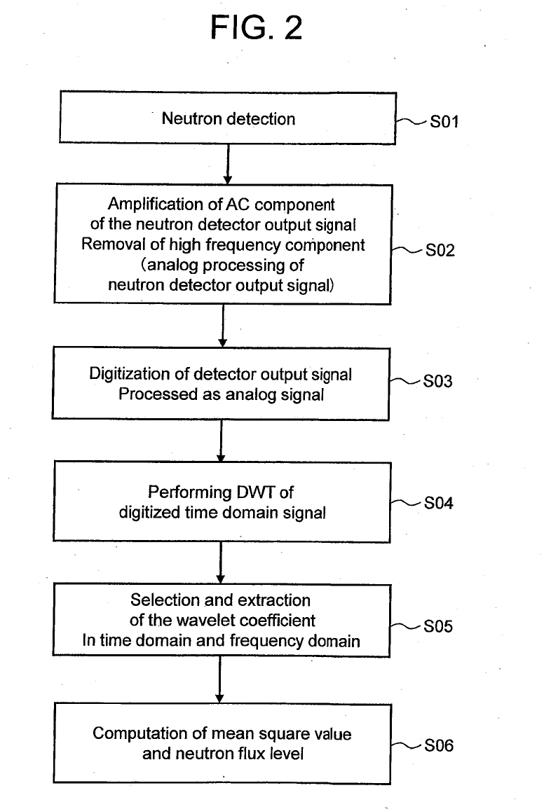

FIG. 2 is a flowchart illustrating a procedure of the neutron flux level measurement method according to the first embodiment. First, neutrons are detected (step S01). When the neutrons are incident to the neutron detector 2, the neutron detector 2 generates a pulse-like detector output signal. When the number of the neutrons incident to the neutron detector 2 is increased, the pulse-like detector output signals overlap each other, and it becomes impossible to discriminate individual pulse-like signals. However, the statistical fluctuation of the output signal of the neutron detector 2 maintains a relative relationship with the number of the neutrons incident to the neutron detector 2, that is, the neutron flux level (or a reactor power on a reactor basis).

The output signal having the statistical fluctuation is weak and is thus amplified by the preamplifier 3. The signal amplified by the preamplifier 3 has a statistical fluctuation similar to the statistical fluctuation of the detector output signal.

Then, analog processing of the output signal of the neutron detection system 1 is performed (step S02). That is, the AC amplifier 11 extracts the statistical fluctuation component, i.e., the AC signal component from the output signal of the preamplifier 3 of the neutron detection system 1 and amplifies it. Further, the analog filter 12 removes, from the output signal corresponding to the AC signal component amplified by the AC amplifier 11, a high-frequency component equal to or higher than a frequency (Nyquist frequency) a half of a sampling frequency of the AD converter 21 at the subsequent stage.

Then, the detector output signal that has been subjected to the analog processing in step S02 is digitized (step S03). That is, the AD converter 21 digitizes, at the above-mentioned predetermined sampling period, the output signal of the analog filter 13. The first memory 22 sequentially memorizes the digital signal.

Then, the wavelet analysis system 30 applies DWT (Discrete Wavelet transformation) to the time domain signal digitized in step S03 (step S04). That is, the wavelet transformation section 31 applies the DWT to the time domain signal to transform the time domain signal into the wavelet coefficient, that is, to compute the wavelet coefficient. Specifically, a certain number of time domain digital signals are read out from the first memory 22 and subjected to the DWT. The wavelet transformation section 31 outputs the same number of wavelet coefficients as the number of digital signals used in the DWT. The obtained wavelet coefficients are stored in the second memory 32.

Assume that there are generated 2^{N} time-series digital signals sampled at a sampling interval ΔT by down-sampling. In this case, a mother wavelet of level 1 is a function of a period of 2ΔT. The mother wavelet of level 1 is used to perform the DWT 2^{N-1} times, whereby 2^{N-1} wavelet coefficients are obtained.

Similarly, a mother wavelet of level 2 is a function having the same shape as the function of the mother wavelet of level 1 and having a period of 2²ΔT. By using the mother wavelet of level 2, 2^{N-2} wavelet coefficients are obtained. A mother wavelet of the last level N is a function having the same shape as the function of the mother wavelet of level 1 and having a period of 2^{N}ΔT. By using the mother wavelet of level N, one wavelet coefficient is obtained. In this manner, a total of 2^{N} wavelet coefficients, that is, the same number of wavelet coefficients as the number of digital signals, are obtained.

Then, the coefficient selection/extraction section 41 of the digital signal processing system 40 selects a necessary wavelet coefficient from the wavelet coefficients computed in step S04. The selection and extraction are performed from both the time domain and the frequency domain (step S05). The signal transformed into the wavelet coefficient by the wavelet transformation section 31 includes both time axis information and frequency axis information indicating, for example, that there exists a signal component of about 100 kHz to about several hundred kHz in data at a certain time or a noise component of about 1 MHz. Therefore, selection and extraction (filtering) of the necessary signal is performed based on the time and frequency information to thereby remove a noise component.

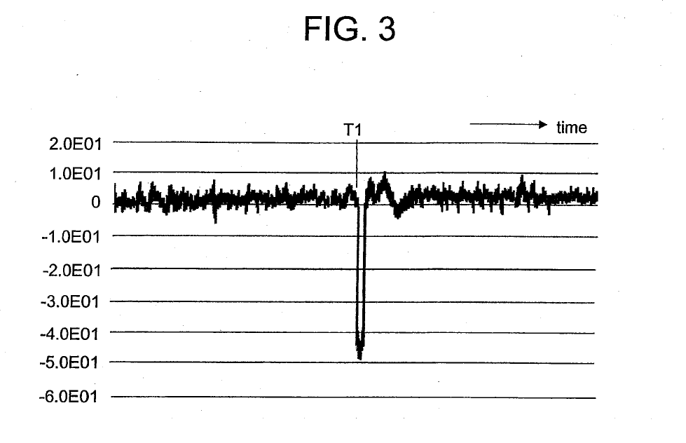

FIG. 3 is a graph illustrating an example of a temporal change of the output signal of the neutron detector. A horizontal axis indicates a time, and a vertical axis indicates a value of the output signal from the neutron detection system 1. At a time T1, large noise is superimposed on the output signal. A result obtained by applying the wavelet transformation to the output signal will be described below.

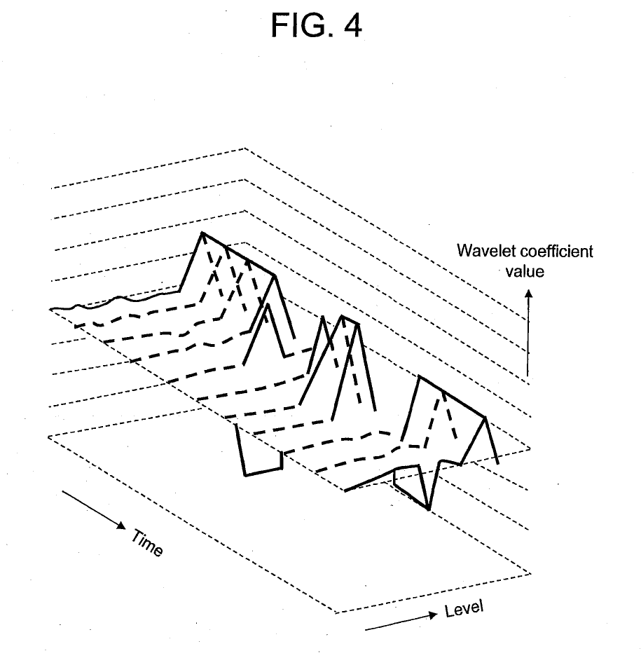

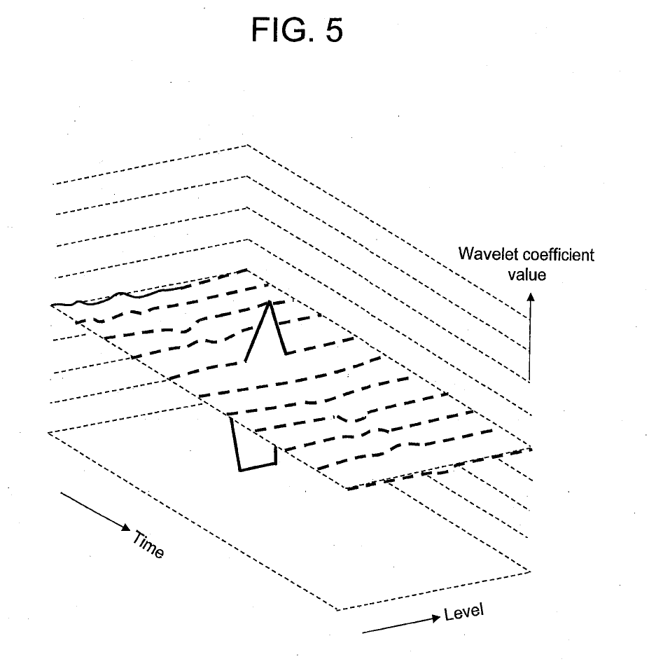

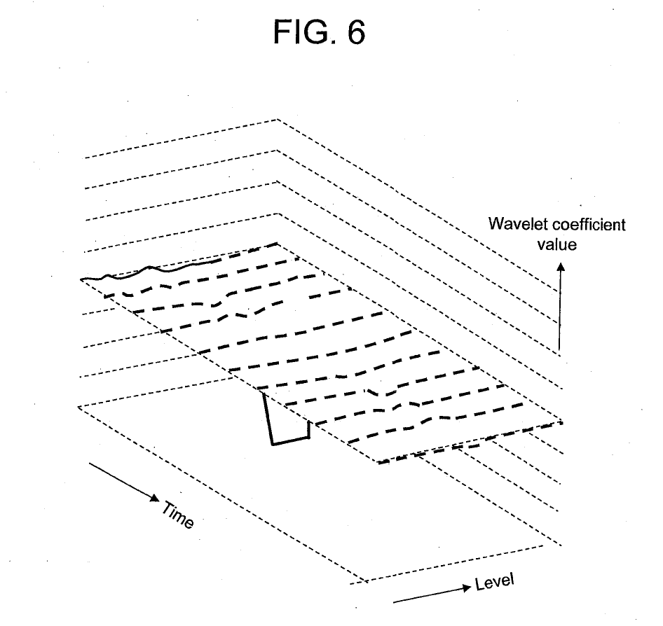

FIG. 4 is a graph illustrating a result of the wavelet transformation. FIG. 5 is a graph illustrating a result of the wavelet transformation in a case where a bandwidth is limited. FIG. 6 is a graph illustrating a result of the wavelet transformation in a case where the bandwidth limitation and noise removal are performed. The graphs of FIGS. 4 to 6 are each a three-dimensional graph, in which one of horizontal axes indicates a time, and the other one thereof perpendicular to the time axis indicates a level obtained through the wavelet transformation. A vertical axis indicates a value of the wavelet coefficient of each level obtained through the wavelet transformation.

FIG. 4 shows a result obtained by applying the wavelet transformation to the output signal from the neutron detection system 1. With the exception of some time regions, a peak appears in a range where the output signal level is highest. The graph also shows a peak corresponding to noise generated at time T1. In this graph, the peak assumes a mountain-like shape, which, however, does not mean that the peak values constitute a continuous mountain-like shape, but is a result merely obtained by connecting values of respective levels on the graph.

FIG. 5 illustrates a result of the wavelet transformation in a case where a bandwidth is limited, that is, where a bandwidth in the frequency domain is limited, in which a high-level peak, i.e., a long period peak is disappeared. FIG. 6 illustrates a result of the wavelet transformation in a case where the bandwidth limitation and noise removal are performed, that is, a result obtained by deleting data around the time T1 at which the large noise occurs. Thus, as illustrated in FIG. 5, a wavelet coefficient value corresponding to the fluctuation having a relative relationship with the neutron flux level is obtained.

Then, as illustrated in FIG. 2, the digital signal processing system 40 computes the mean square value to thereby compute the neutron flux level (step S06). That is, the mean square value computing section 42 computes the mean square value of the selected wavelet coefficients, that is, a value obtained by dividing the square sum by the number of data. Thus, the neutron flux level conversion section 43 converts the output signal of the mean square value computing section 42 into a neutron measurement value.

As described above, the neutron flux level conversion section 43 performs processing for the mean square value to correct the attenuation effect thereon due to presence of a low-pass filter for sampling performed in the AD converter 21 and the bandwidth limitation and noise reduction by the coefficient selection/extraction section 41, and to further correct sensitivity of the neutron detector 2, whereby a neutron level signal can be obtained.

Further, like the fluctuation component of the output of the neutron detector 2 in the time domain, the mean square value of the wavelet coefficients corresponds to the neutron flux level, thereby eliminating the need to perform inverse transformation (iDWT) of the DWT.

For example, a gate array type element (programmable logic device (PLD), or a field programmable gate array (FPGA), or others) for performing computation in a hardware logic has a smaller computation logic capacity that can be implemented, compared to a microprocessor (MPU) or a digital-signal processor (DSP) that performs computation by a program. Thus it is quite difficult to implement both the DWT and the iDWT. The present embodiment, however, eliminates the needs of the implementation of the iDWT, which enhances implementability.

In the neutron measurement method in a conventional neutron measurement device, the detector output signal in the time domain is detected, and is subjected to the analyzing computation processing for monitoring. When the frequency component of the neutron signal to be measured overlaps the frequency component of a noise signal, it is difficult to avoid influences of the noise. On the other hand, according to the present embodiment, even in a state where the frequency component of the neutron signal overlaps the frequency component of the noise signal, when the noise is not stationary, that is, when a time at which the noise is superimposed on the neutron signal can be specified, it is possible to discriminate the wavelet coefficient at a time at which the noise is superimposed on the neutron signal, and remove the noise in the time domain, thereby quickly obtaining the neutron measurement value in which influences of the noise signal are removed.

As described above, according to the present embodiment, it is possible to quickly perform measurement of the neutron flux level while removing the influences of the noise.

### Second Embodiment

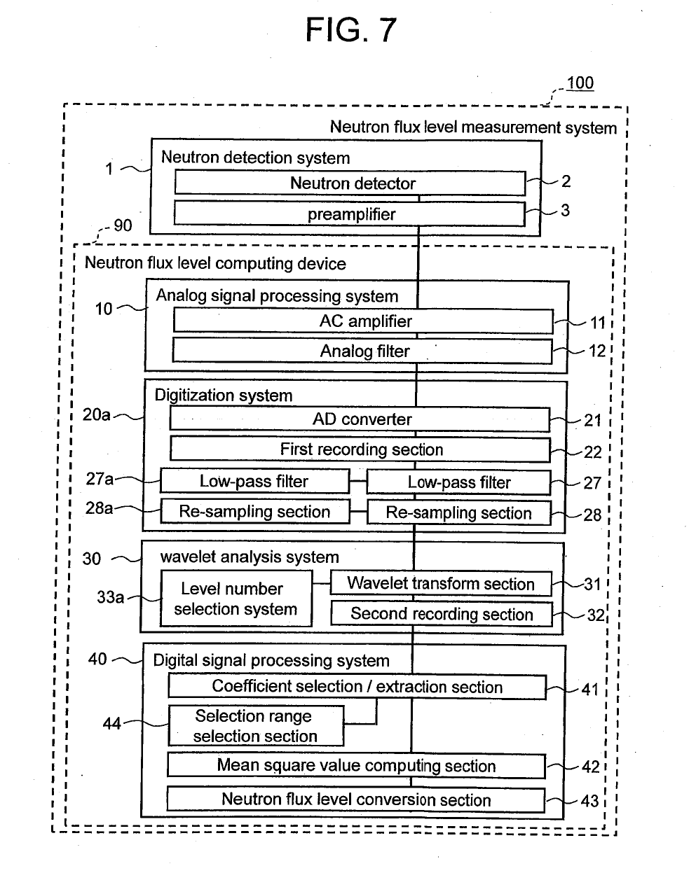

FIG. 7 is a block diagram illustrating a configuration of the neutron flux level measurement system according to a second embodiment. The second embodiment is a modification of the first embodiment. A digitization system 20a of the neutron flux level computing device 90 according to the second embodiment further includes a low-pass filter 27, a low-pass filter 27a, a re-sampling section 28, re-sampling section 28a, a level number selection section 33, and a selection range switching section 44, adding to the AD converter 21 and the first memory 22.

The re-sampling section 28 and re-sampling section 28a can resample the data sampled by the AD converter 21 at their respective sampling frequencies lower than the sampling frequency of the AD converter 21. The low-pass filter 27 removes a frequency component equal to higher than ½ of the re-sampling frequency of the re-sampling section 28. Further, the low-pass filter 27a removes a frequency component equal to or higher than ½ of the re-sampling frequency of the re-sampling section 28a.

The level number selection section 33 can changeably select the number of DWT levels. The selection range switching section 44 adjusts a change in correspondence between a signal after the DWT and a frequency range of the neutron signal when the re-sampling frequency is changed or when the level number selection section 33 changes the number of DWT levels.

According to the present embodiment, when the neutron signals in the same time range are measured, re-sampling is performed at a sampling frequency lower than the sampling frequency of the AD converter 21. This allows application of the DWT of a lower number of levels, enhancing implementability to the neutron flux level computing device 90.

Further, by making the re-sampling frequency selectable, a time range for which the DWT is performed is made variable in a case where the DWT using the same number of data is performed. This makes standard deviation due to the statistical fluctuation of the measured neutron signal or responsiveness to a neutron signal change selectable.

Further, in the frequency domain, it is possible to make a frequency range to be measured selectable by changing the sampling frequency and the number of wavelet transformation levels, thus making it possible to set an adequate frequency range according to a frequency of the neutron signal to be measured. That is, when a rapid change of the neutron signal is measured, an upper limit of the frequency to be measured can be increased by setting the sampling frequency to a higher value; on the other hand, when a slow change of the neutron signal is measured, an upper limit of the frequency to be measured can be decreased by setting the sampling frequency to a lower value. Further, it is possible to extend a frequency range to be measured by increasing the number of wavelet transformation levels; on the other hand, it is possible to narrow a frequency range to be measured by decreasing the number of wavelet transformation levels.

### Third Embodiment

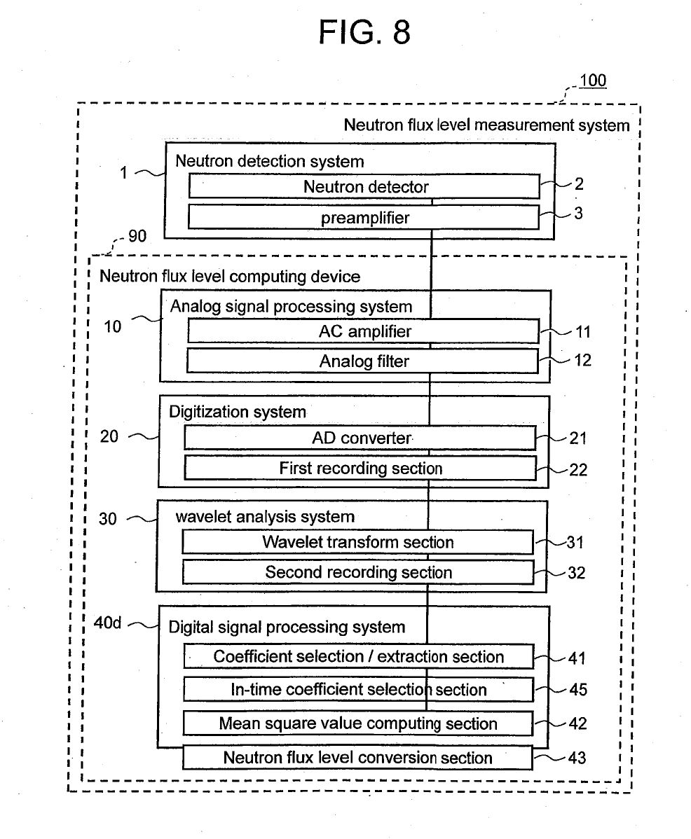

FIG. 8 is a block diagram illustrating a configuration of the neutron flux level measurement system according to a third embodiment. The third embodiment is a modification of the first embodiment. A digital signal processing system 40a of the neutron flux level computing device 90 according to the third embodiment further includes an in-time coefficient selection section 45 adding to the coefficient selection/extraction section 41, the mean square value computing section 42, and the neutron flux level conversion section 43. The in-time coefficient selection section 45 selects wavelet coefficients corresponding to a certain time width and outputs the selected wavelet coefficients to the mean square value computing section 42.

In the present embodiment, when the DWT is performed for time-axis data corresponding to a long time, the in-time coefficient selection section 45 selects some of the wavelet coefficients after the DWT according to responsiveness and measurement accuracy required for the neutron flux level measurement system 100. As described above, it is possible to change a time width to be selected after the DWT by utilizing a fact that the DWT retains time information, thereby making it possible to adjust the accuracy and responsiveness of the neutron measurement without changing a DWT logic itself.

### Fourth Embodiment

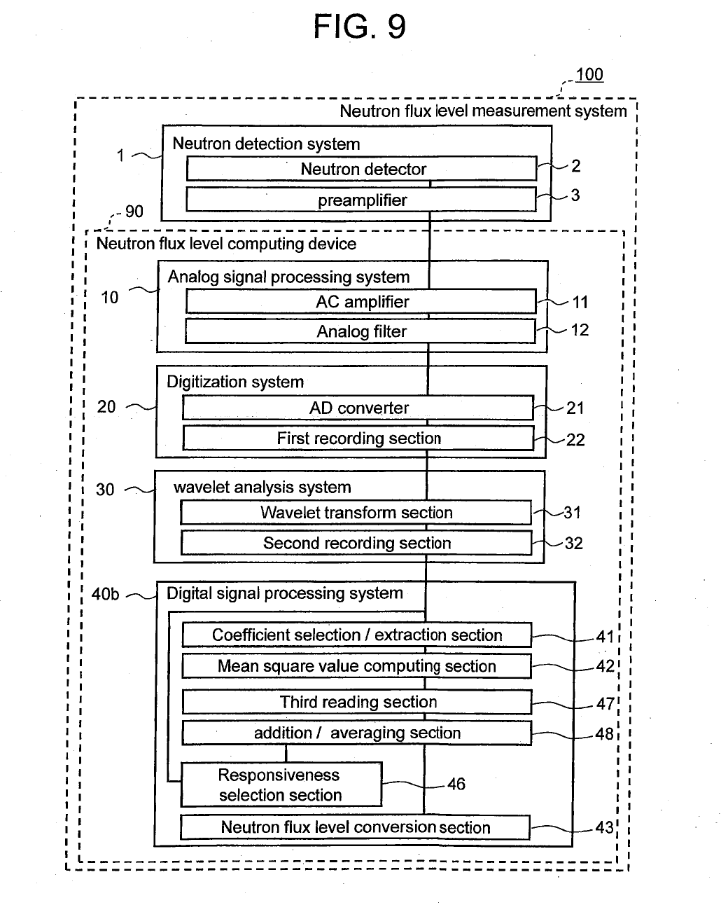

FIG. 9 is a block diagram illustrating a configuration of the neutron flux level measurement system according to a fourth embodiment. The fourth embodiment is a modification of the first embodiment. A digital signal processing system 40b of the neutron flux level computing device 90 according to the fourth embodiment further includes a responsiveness selection section 46, a third memory 47, and an addition/averaging section 48 adding to the coefficient selection/extraction section 41, the mean square value computing section 42, and the neutron flux level conversion section 43.

The responsiveness selection section 46 can select the accuracy, standard deviation, or responsiveness of the neutron flux level measurement result. The third memory 47 memorizes the mean square value computed by the mean square value computing section 42. The addition/averaging section 48 adds and averages a plurality of the mean square values. The number of the mean square values to be added and averaged by the addition/averaging section 48 is variable depending on the accuracy, standard deviation, or responsiveness selected by the responsiveness selection section 46.

According to the present embodiment, it is possible to obtain a value equivalent to the mean square value obtained by single DWT collectively performed for data corresponding to a longer time. That is, by adding and averaging the plurality of mean square values obtained through the DWT performed for a smaller number of data corresponding to a shorter time, it is possible to obtain a mean square value which is originally obtained by performing the DWT for a larger number of data corresponding to a longer time. This can reduce a necessary capacity of the DWT logic part, thus enhancing implementability. By measuring the neutron signal for a longer time while shortening DWT execution time to enhance the responsiveness of the monitoring of the neutron signal, the measurement accuracy can be improved. Further, by making the number of the mean square values to be added and averaged variable, the accuracy or responsiveness of the neutron signal measurement is made selectable.

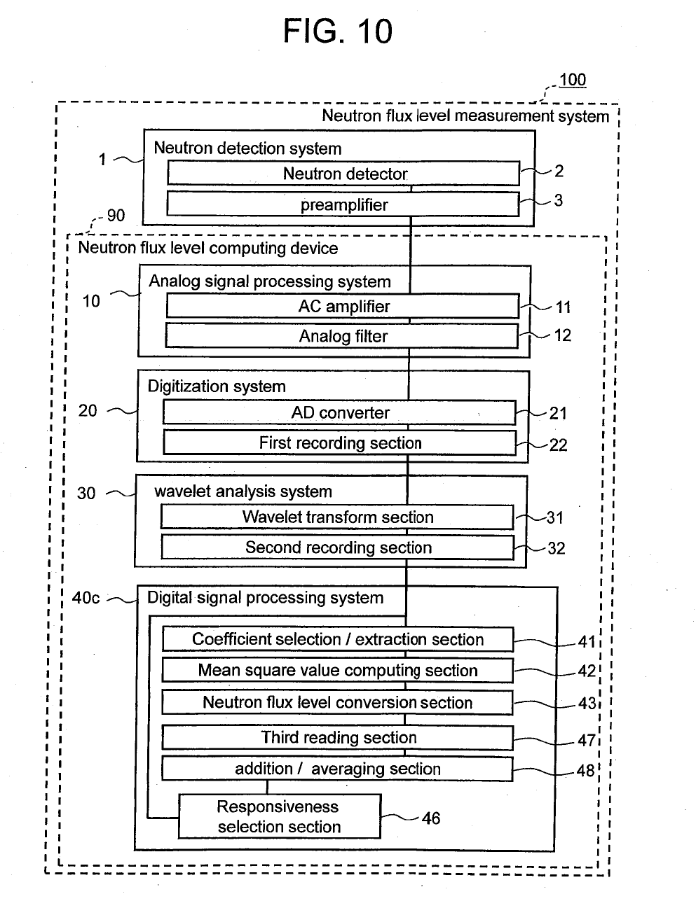

FIG. 10 is a block diagram illustrating a configuration of a modification of the neutron flux level measurement system according to the fourth embodiment. The present embodiment is a modification of the first embodiment. A digital signal processing system 40c according to this modification includes the responsiveness selection section 46, third memory 47, and addition/averaging section 48 like the fourth embodiment but differs from the fourth embodiment in transmission and reception relationship of input and output data.

That is, in addition to the coefficient selection/extraction section 41, the mean square value computing section 42, and the neutron flux level conversion section 43 of the first embodiment, the third memory 47 memorizes a conversion result of the neutron flux level conversion section 43. The addition/averaging section 48 adds and averages the coefficients read out from the third memory 47. At this time, the responsiveness selection section 46 that can select the accuracy, standard deviation, or responsiveness of the neutron flux level measurement result adjusts a computation range of the addition/averaging section 48.

According to the present modification, the same effects as those obtained in the fourth embodiment can be obtained.

### Fifth Embodiment

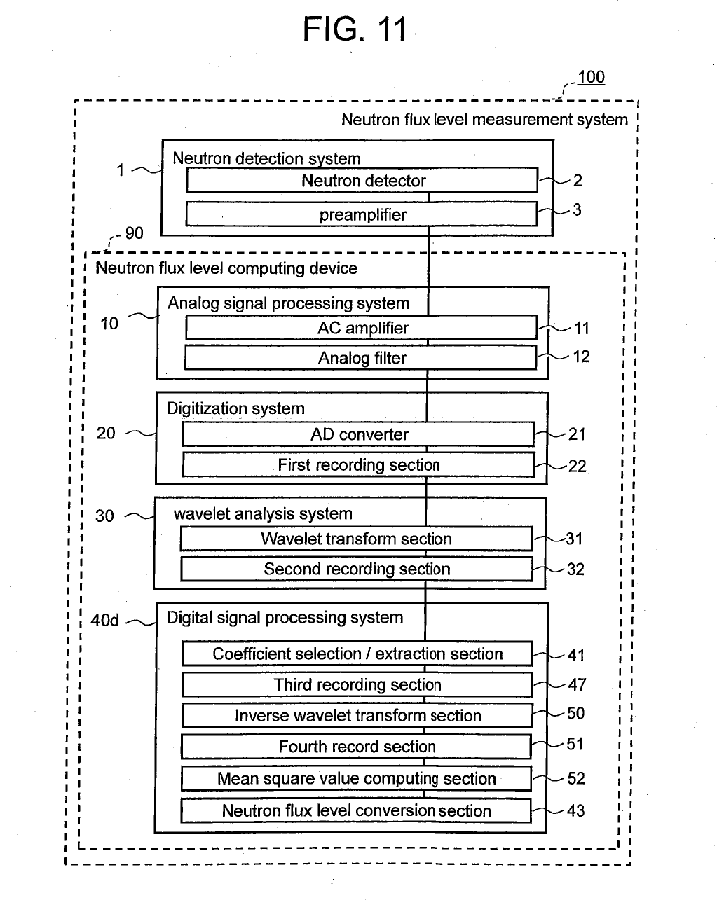

FIG. 11 is a block diagram illustrating a configuration of the neutron flux level measurement system according to a fifth embodiment. The present embodiment is a modification of the first embodiment. A digital signal processing system 40d of the neutron flux level computing device 90 according to the fifth embodiment further includes a third memory 47, an inverse wavelet transformation section 50, a fourth memory 51, and a mean square computing section 52 adding to the coefficient selection/extraction section 41 and the neutron flux level conversion section 43.

The inverse wavelet transformation section 50 reads out, from the third memory 47, the wavelet coefficient selected by the coefficient selection/extraction section 41 and applies inverse wavelet transformation (iDWT). Application of the iDWT transforms time/frequency domain data into time domain data. The fourth memory 51 memorizes a result of the iDWT. The mean square computing section 52 reads out the time domain data from the fourth memory 51 and computes a mean square of the time domain data.

In the neutron flux level computing device 90 according to the present embodiment, the wavelet analysis system 30 performs the DWT, and the coefficient selection/extraction section 41 of the digital signal processing system 40d performs filtering in the time and frequency domains to thereby remove a noise component. Thereafter, the iDWT is performed to inversely transform the time/frequency domain data into time domain data. The results are squared and averaged, and the resultant value is converted into a value of the neutron flux level by the neutron flux level conversion section 43.

As described above, also by performing the iDWT, it is possible to obtain a neutron measurement value in which a noise component is removed while preventing mixing of a noise signal, whereby the neutron flux level can be measured with accuracy.

### Sixth Embodiment

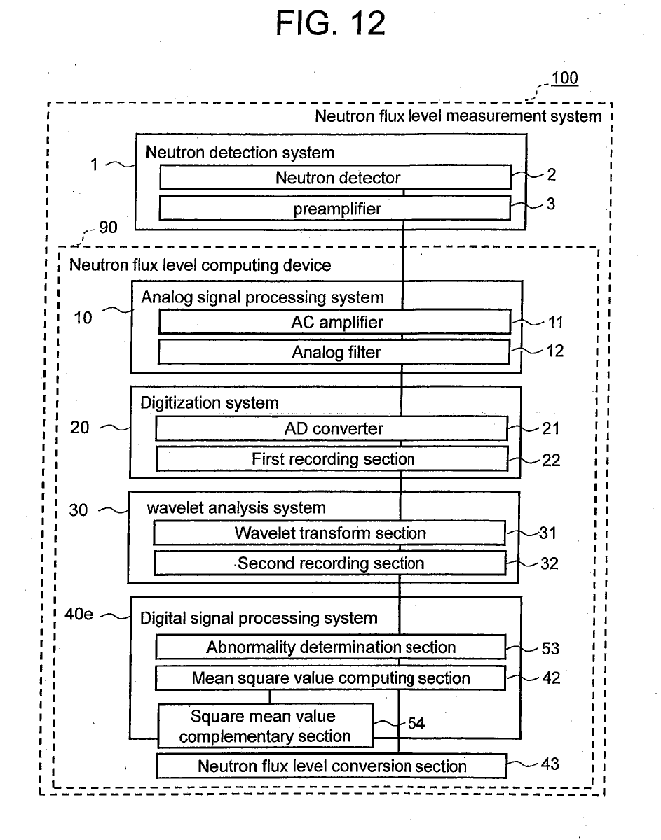

FIG. 12 is a block diagram illustrating a configuration of the neutron flux level measurement system according to a sixth embodiment. The present embodiment is a modification of the first embodiment. A digital signal processing system 40e of the neutron flux level computing device 90 according to the sixth embodiment further includes an abnormality determination section 53 and a mean square value complementary section 54.

The abnormality determination section 53 determines whether or not any of the wavelet coefficients obtained by the wavelet analysis system 30 has an abnormal value due to influences of a noise signal. When the abnormality determination section 53 determines that any of the wavelet coefficients obtained by the wavelet analysis system 30 has an abnormal value, the mean square value complementary section 54 computes a mean square value through interpolation or extrapolation using a previous mean square value obtained by the mean square value computing section 42 to complement the wavelet coefficient. The complementary may be made by using a mean square value obtained in, e.g., a former computation before previous computation by the mean square value computing section 42.

In the present embodiment, presence/absence of the abnormality of the wavelet coefficient is determined, and when the abnormality is present, a regular mean square computation is not performed, but complementary is made based on, e.g., the previous or next mean square value. This eliminates the need to perform selection/extraction of the wavelet coefficient, thereby eliminating the need to implement a computational logic for selection and extraction. Thus, it is possible to quickly perform measurement of the neutron flux level while removing the influences of the noise.

### Other Embodiments

While the present invention is described above by way of several embodiments, the above described embodiments are presented only as examples without any intention of limiting the scope of the present invention.

Any of the characteristic features of two or more than two of the above described embodiments may be combined for use.

Furthermore, the above described embodiments may be modified in various different ways. For example, any of the components of the embodiments may be omitted, replaced or altered without departing from the spirit and scope of the invention.

All those embodiments and their modifications are within the spirit and scope of the present invention specifically defined in the appended claims and their equivalents.

What is claimed is:

1. A neutron flux level computing device comprising:
an analog signal processing system that amplifies an AC component of a detector output signal from a neutron detector and performs filtering for removal of a high-frequency component;
a digitization system that converts, at a certain sampling period, an output signal from the analog signal processing system into a digital time-series signal;
a wavelet analysis system that performs discrete wavelet transformation using the digital time-series signal to compute a wavelet coefficient; and
a digital signal processing system that computes a mean square value of the wavelet coefficients and converts the computed mean square value into a neutron flux level value.

2. The neutron flux level computing device according to claim 1, wherein
the wavelet analysis system includes the wavelet transformation section that applies discrete wavelet transformation to the digital time-series signal using an orthonormal basis to compute the same number of the wavelet coefficients as the number of the digital time-series signals.

3. The neutron flux level computing device according to claim 1, wherein
the digital signal processing system includes:
a coefficient selection/extraction section that selects, from a result of the computation performed by the wavelet analysis system, the wavelet coefficient having a necessary frequency component;
a mean square computing section that computes the mean square value of the coefficient selected by the coefficient selection/extraction section; and
a neutron flux level conversion section that converts the mean square value into a neutron flux level value.

4. The neutron flux level computing device according to claim 3, wherein
the coefficient selection/extraction section is configured to changeably select a frequency range, and
the neutron flux level conversion section is configured to perform conversion for the selected frequency range.

5. The neutron flux level computing device according to claim 3, wherein
the coefficient selection/extraction section is configured to changeably select a time range, and
the neutron flux level conversion section is configured to perform conversion for the selected time range.

6. The neutron flux level computing device according to claim 1, wherein
the analog signal processing system includes:
an AC amplification section that amplifies the AC component of an output of a preamplifier which amplifies the output of the neutron detector; and
an analog filter that removes a component of the high-frequency region from a signal of the AC amplifier.

7. The neutron flux level computing device according to claim 1, wherein
the digitization system includes:
a low-pass filter that performs low-pass filtering for the digital time-series signal; and
a re-sampling section that re-samples the digital time-series signal at a period longer than a sampling period for the digital time-series signal.

8. A neutron flux level measurement system, comprising:
a neutron detector that detects neutrons generated by nuclear reaction; and
a neutron flux level computing device that computes a neutron flux level based on a signal from the neutron detector, the device including:
an analog signal processing system that amplifies an AC component of a detector output signal from a neutron detector and performs filtering for removal of a high-frequency component;
a digitization system that converts, at a certain sampling period, an output signal from the analog signal processing system into a digital time-series signal;
a wavelet analysis system that performs discrete wavelet transformation using the digital time-series signal to compute a wavelet coefficient; and
a digital signal processing system that computes a mean square value of the wavelet coefficients and converts the computed mean square value into a neutron flux level value.

9. A neutron flux level measurement method comprising:
an analog signal processing step of amplifying an AC component of a detector output signal from a neutron detector and of performing low-pass filtering for removal of a high-frequency component;
a digitization step of digitizing, at a certain sampling period and in a time-series manner, the detector output signal that has been subjected to the low-pass filtering;
a wavelet transformation step of performing discrete wavelet transformation to the digitized detection output signal into wavelet coefficients; and
a level value conversion step of computing a mean square value of some wavelet coefficients selected from the wavelet coefficients obtained through the discrete wavelet transformation and converting the computed mean square value into a neutron flux level value.
